(19) United States
(12) Patent Application Publication
(10) Pub. No.: US 2025/0226510 A1
(43) Pub. Date: Jul. 10, 2025

(54) BATTERY SYSTEM FOR WEARABLE HEADGEAR DEVICE

(71) Applicant: RealWear, Inc., Vancouver, WA (US)

(72) Inventors: Chris Iain PARKINSON, Richland, WA (US); Noah Nicholas BALMER, Vancouver, WA (US); George Henry HINES, Petaluma, CA (US)

(21) Appl. No.: 18/405,808

(22) Filed: Jan. 5, 2024

(51) Int. Cl. H01M 50/247; H01M 50/256; H01M 50/262; H02J 7/00

(52) U.S. Cl. CPC H01M 50/247; H01M 50/256; H02J 7/0063; H01M 50/262; H01M 2220/30

(57) ABSTRACT

A battery system for a headgear includes a battery housing assembly. The battery housing assembly has a first housing end opposite a second housing end. The battery housing assembly also has a fixed length strap extending from the battery housing assembly at the first housing end and a variable length strap extending from the battery housing assembly at the second housing end. The battery housing assembly has a fixed length power cable extending from the battery housing assembly and through the fixed length strap, where the fixed length power cable electrically couples a battery contact of the battery housing assembly to a charging port of the headgear.

### BACKGROUND

Wearable device are commonplace. For example, wearable cameras are devices that may be mounted on headgear to generally allow a user to capture imagery within a field of view (FOV) of the camera. The wearable device requires a power source that can be plugged to a power source, or for increased portability, may be powered through a battery source.

### SUMMARY

At a high level, aspects described herein relate to a battery housing system and battery for headgear equipment. The battery housing system and battery include power distribution circuitry for providing power to an electronic device of the headgear (e.g., a wearable camera). The power distribution circuitry also contains battery charging circuitry to manage recharging of the battery. Optionally, the battery housing system and battery may further include a battery monitoring circuit that is operable to provide a status of one or more battery status indicators, such as remaining capacity, temperature, voltage, electrical current consumption, and the like to various components of the electronic device of the headgear.

The battery housing in accordance to aspects herein is electrically coupled to a charging port of the headgear via a fixed length power cable. The fixed length cable can extend along or within a fixed length strap of the headgear. This allows for the battery housing system and battery to be positioned at a fixed length from the charging port on one side of the headgear and a variable length from the charging port on the opposite side of the headgear. As such, the battery housing system and battery's position on a wearer's head can change based on a wearer's head circumference, or on the wearer's headwear circumference such as a hat, cap, and the like, or a wearer's protective equipment circumference such as, a hard hat. In other words, rather than always being positioned on the back of the wearer's head, the battery housing system and battery may be positioned offset from the back and getting closer towards the wearer's temple, as the head or headwear circumference increases.

### BRIEF DESCRIPTION OF THE DRAWINGS

The present technology is described in detail below with reference to the attached drawing figures, wherein:

FIG. 1 illustrates a front perspective view of an example of a headgear, in accordance with aspects herein;

FIG. 2 illustrates a back perspective view of the headgear shown in FIG. 1, in accordance with aspects herein;

FIGS. 3A and 3B illustrate a battery system for headgear, in accordance with aspects herein;

FIG. 4 illustrates a battery housing assembly component for headgear, in accordance with aspects herein;

FIG. 5 illustrates a battery component for headgear, in accordance with aspects herein;

FIGS. 6A and 6B illustrate an “unlocked” state and “locked” state, respectively, in accordance with aspects herein;

FIGS. 7A and 7B illustrate a partial cross-sectional view of the battery system for headgear, in accordance with aspects herein;

FIG. 8 illustrates a deconstructed view of the battery system for headgear, in accordance with aspects herein; and

FIG. 9 illustrates the electrical connection between the battery system and the charging port, in accordance with aspects herein.

### DETAILED DESCRIPTION

Conventional camera-based headgear often encounters several problems, particularly when integrating the camera and battery system in a single unit. Conventional headgear are often not versatile enough to be comfortably used in a variety of settings, from professional tasks to recreational activities.

For example, in traditional designs, where the camera and battery system are housed together, there tends to be an uneven weight distribution. This can cause imbalance of the device, especially during extended use. Conventional headgear often lacks sufficient adjustability to accommodate different head sizes and shapes comfortably. Integrating the battery system with the camera often limits the size and capacity of the battery system, reducing operational time. Conventional headgear can also make it challenging to replace or upgrade individual components like the battery system or camera, often necessitating the replacement of the entire unit. The front-heavy design of traditional headgear may also fail to counterbalance the weight effectively. Incorporating a battery system within the camera module often results in bulkier and heavier camera units, which can be obtrusive and less comfortable for the user. Furthermore, the lack of integrated cable management in traditional designs can lead to issues with entanglement, inconvenience, and a less streamlined appearance. Moreover, conventional systems that include batteries near device processing units tend to reduce the battery lifespan because of the heat generated by the processing units during use. Overall, these design limitations can compromise the user experience, with reduced comfort, convenience, and functionality.

In order to address these issues, the technology described herein includes a battery assembly and camera-based wearable headgear that include separate components, balanced weight distribution, and improved adjustability without sacrificing cable management considerations to enhance user comfort and the overall functionality of the headgear. For example, separating the battery system from the camera in wearable headgear, where the camera is mounted at the front and the battery system is placed a fixed distance away closer to the back of the user's head, offers several advantages, particularly when considering functionality aspects and battery life. By positioning the battery system a fixed distance away closer to the back and the camera at the front, the headgear achieves a more balanced weight distribution. This minimizes imbalance and enhances user comfort, especially during prolonged use. It also removes the battery from close contact with processing units that might reduce battery lifespan. In aspects, the batter is located a fixed length from the camera device via the fixed length strap, such that the position is offset from the center rear of the head, allowing users to comfortably work using the camera while lying on their back. As an example, the fixed length strap may be eight inches or less to accommodate this utility. Furthermore, the use of a fixed-length strap with integrated power cables that connect the battery system to the camera ensures a stable and secure fit, as it prevents excessive movement of the headgear.

At the same time, the variable-length strap allows for adjustability, accommodating different head sizes and shapes, and enabling users to find the most comfortable fit. Additionally, integrating power cables into one of the straps not only serves a functional purpose but also helps in managing and concealing cables, reducing the risk of entanglement. Additionally, damage to the cable is prevented, since the strap adjustments are generally made using the variable length strap. Placing the heavier battery system at the back can help counterbalance the weight of the camera at the front, which can help overall stability of the headgear.

According to aspects herein, a separate battery system also allows for the inclusion of a larger or more efficient battery without adding bulk to the camera module. This can lead to longer operational times and potentially faster charging capabilities. Furthermore, separating the battery system from the camera module makes it easier to replace or upgrade individual components. If the battery system degrades or a more advanced camera is needed, only the specific part can be swapped out without the need to replace the entire headgear. With the battery system housed separately, the camera unit can also be made more compact and lightweight. This can lead to a less obtrusive design and may offer more flexibility in terms of camera module design and placement. In summary, the camera-based headgear presently disclosed offers ergonomic and functional benefits, making the device more user-friendly and adaptable to various needs and environments when compared to conventional wearable devices such as, for example, camera-based headgear and the like.

One example of a suitable headgear can have a battery system for a headgear having a battery that is spaced apart from the device being powered. The battery system includes a battery housing assembly having a first housing end opposite a second housing end with a fixed length strap of the headgear extending from the battery housing from the first housing end. A variable length strap of the headgear extends from the battery housing assembly from the second housing end. Additionally, a power cable extending from the battery housing assembly from the first housing end electronically couples the battery housing assembly and a charging port. The power cable extends through the fixed length strap. The charging port can be, for example, in a camera or other device of the headgear. When the variable length strap is in a fully retracted state, the variable length strap can be shorter than the fixed length strap, and when it is in a fully extended state, the variable length strap is longer than the fixed length strap.

The battery housing assembly of the battery system can include a housing rail extending between the first housing end and the second housing end with a battery rail receiving site at a location nearer to the second housing end than the first housing end. Additionally, the battery housing assembly can include a release slide that protrudes through a release slide opening at the second housing end, such that the release slide is biased toward a first longitudinal housing side. Moving the release slide directionally between the first longitudinal housing side and a second longitudinal housing side respectively positions a battery latch between a locked position and an unlocked position.

Further, the battery housing assembly also includes a top surface having a top surface opening, such that the battery latch extends through the top surface opening at a location nearer to the second housing end than the first housing end. The battery contact of the battery housing assembly can be positioned within a first lateral housing side of the battery housing assembly. The release slide protrudes through an opening in the second housing end. As described above, the headgear has a fixed length strap through which the battery housing assembly and the charging port are connected. The fixed length power cable is molded (e.g., overmolded or press molded) by a polymer-based material, whereby the molded polymer-based material at least partially encases the power cable along the fixed length strap.

The aforementioned aspects of the invention have been provided as examples of the technology that may be practiced from the present disclosure. They are intended to be examples and are provided to aid in understanding the technology and its benefits. Additional features and examples are further described with reference to the figures.

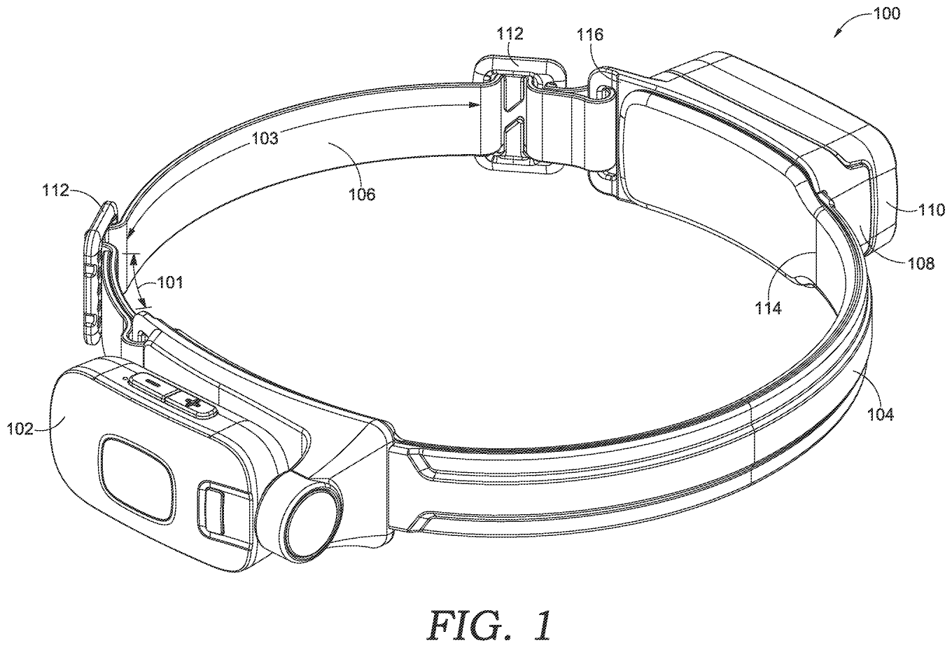

With reference to FIG. 1, a front perspective view of an example headgear 100 is shown in its fully assembled state. The headgear 100 of the present invention can provide a variety of benefits. These benefits include balanced weight distribution, adjustability and comfort, efficient cable management, and the like.

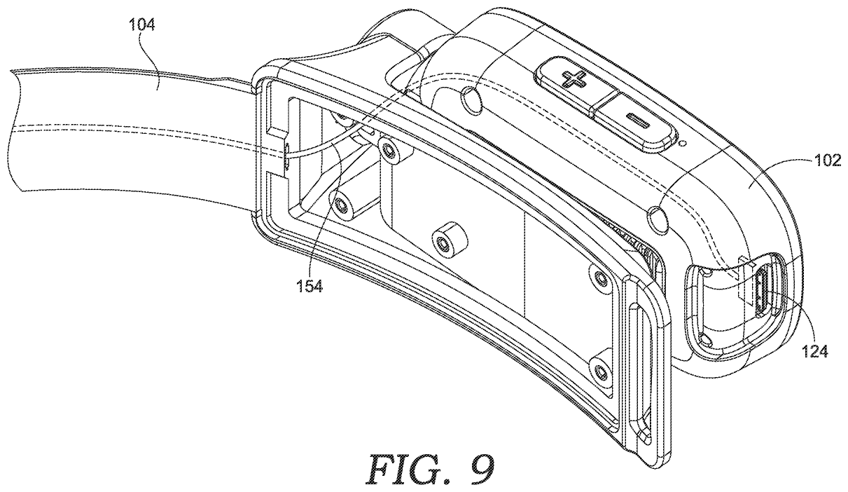

The headgear 100 includes a device 102, such as, a wearable camera. While illustrated as a wearable camera system, a wearable camera is only one example of the device 102. Device 102 may include other devices, such as lights or head-mounted displays. Further, the headgear 100 includes a battery housing assembly 108 and a battery 110 that is electrically connected to the device 102 via a power cable 154 (shown in FIGS. 9A and 9B) enclosed within a fixed length strap 104 that couples the device 102 and the battery housing assembly 108.

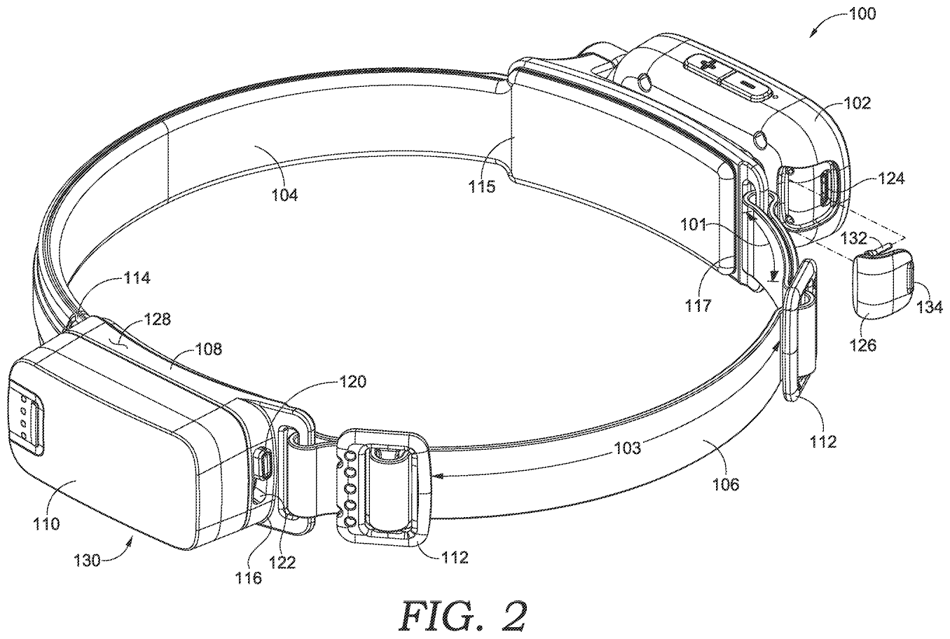

The battery housing assembly 108, as shown in FIGS. 1 and 2, the housing assembly 108 is defined by a first housing end 114 and a second housing end 116 located opposite to the first housing end 114, a first lateral housing side 128 and a second lateral housing side 130 (shown in FIG. 2) located opposite to the first lateral housing side 128. The first housing end 114 is connected to the fixed length strap 104 such that the fixed length strap 104 extends away from the battery housing assembly 108 toward a first device end 115 of the device 102, while the variable length strap 106 is connected to the second housing end 116 such that the variable length strap 106 extends away from the battery housing assembly 108 toward a second device end 117 of the device 102. The fixed length strap 104 is further connected to the device 102 at the first device end 115 and the variable length strap 106 is further connected to the device 102 at the second device end 117 to complete the circumference of the headgear 100.

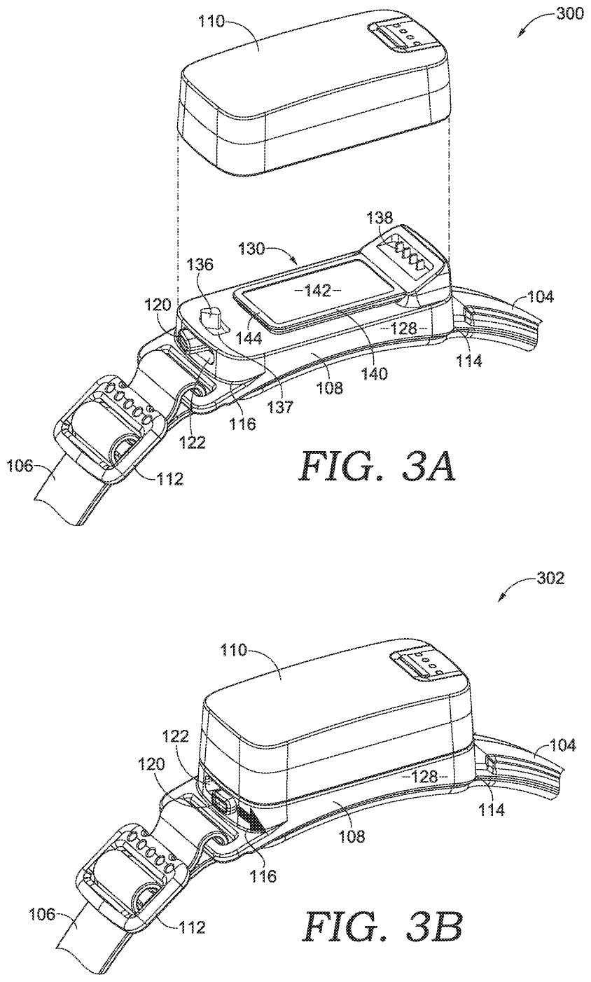

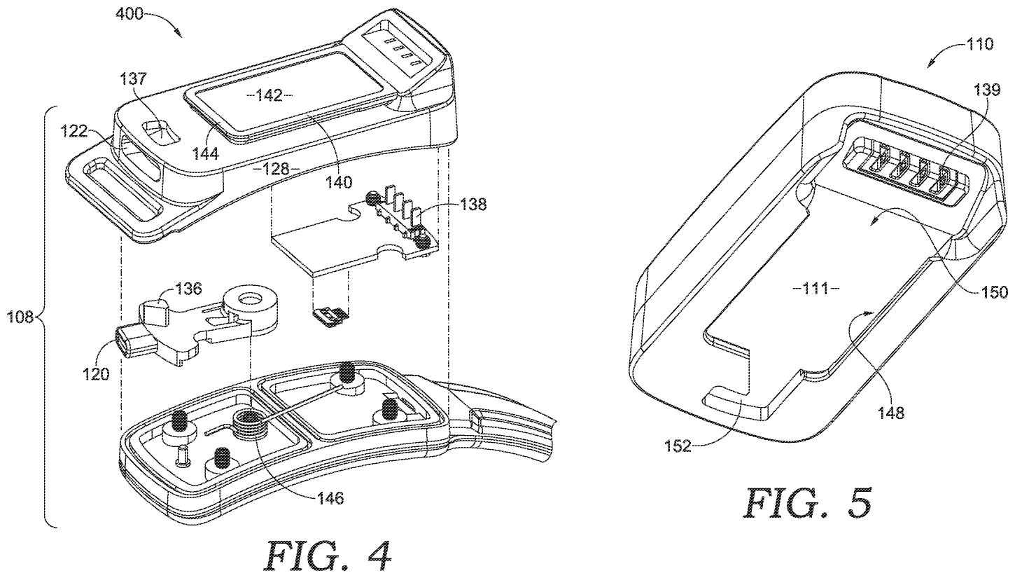

The battery housing assembly 108 further includes a release slide 120 protruding from a release slide opening 122 located on the second housing end 116, as illustrated in FIG. 2. However, it is also contemplated that the release slide 120 and the release slide opening 122 may be located on the first housing end 114. When the release slide is biased toward, for example, the first lateral housing side 128, the battery 110 may be locked to the battery housing assembly 108 signaling a locked position of the release slide 120. However, it is also contemplated that the release slide 120 may be biased toward the second lateral housing side 130 to be in the locked position. A user may apply a force toward the opposite lateral housing side (toward the second lateral housing side 130 starting from the first lateral housing side 128, as shown in FIG. 3A) to unlock the battery 110 from the battery housing assembly 108 signaling an unlocked position of the release slide 120. In some examples, the release slide 120 may be optionally spring loaded with spring 146 (as shown in FIG. 4) such that the release slide 120 is always biased toward, for example, the first lateral housing side 128 when no force toward the second lateral housing side 130 is applied to it to, however, a springless switch type, push type, or other mechanisms that may effectively lock and unlock the battery 110 from the battery housing assembly 108 are also contemplated.

As further shown in the disassembled state 300 of the battery housing assembly 108 and the battery 110 provided in FIG. 3A, the battery housing assembly 108 further comprises a battery latch 136 protruding from a top surface opening 137 located on a top surface 142 of the battery housing assembly 108. As illustrated in FIG. 4, the release slide 120 is connected to the battery latch 136 such that movement of the release slide 120 effectively causes movement of the battery latch 136 in the same direction as the release slide 120. Further, the top surface 142 of the battery housing assembly 142 includes a housing rail 140 with a rail receiving site 144 that is configured to engage and secure the battery 110 to the battery housing assembly 108.

Returning now to FIG. 3A, the battery housing assembly 108 further includes battery contact 138 located on the first housing end 114 and opposite to the release slide 120. The battery contact 138 is configured to create electrical communication between the battery and the battery housing assembly 108 when the battery 110 is locked to the battery housing assembly 108.

As shown in the assembled state 302 of the battery housing assembly 108 and the battery 110 provided in FIG. 3B the battery 110 can be a removable battery that is locked to the battery housing assembly 108 when the release slide is returned to its initial sate, which in the shown example, is biased toward the first lateral housing side 128.

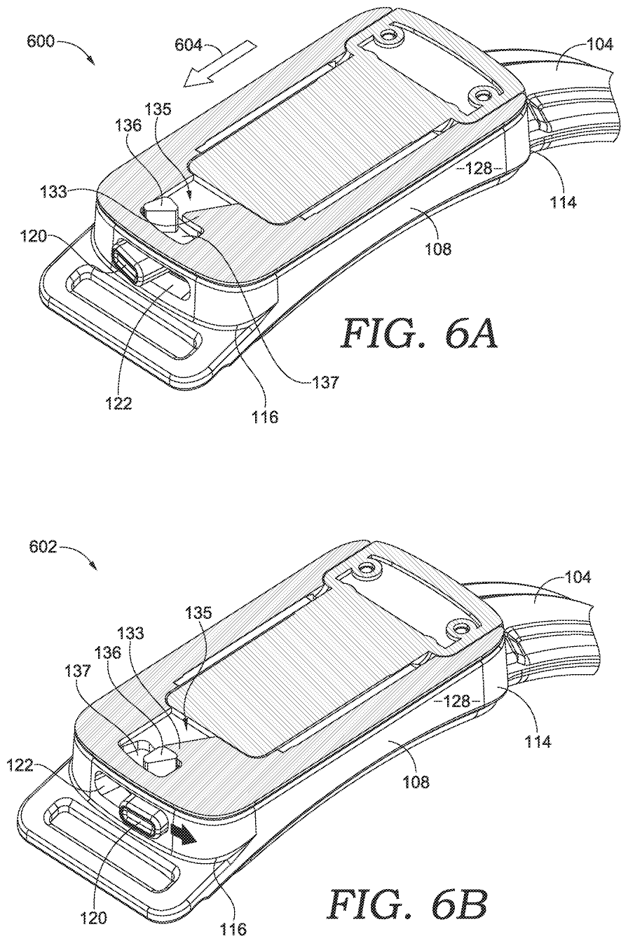

As shown in FIG. 5, the underside 111 of the battery 110 has a battery rail slot 148, which in turn includes an open end 150 and a closed end 152. The battery rail receiving site 144 and the housing rail 140 are configured to enter the battery rail slot 148 through the open end 150 and the battery latch 136 is configured to engage and interact with the closed end 152, which has a guide 135 to unlock 600 (shown in FIG. 6A) and lock 602 (shown in FIG. 6B) the battery latch 136. In other words, as shown in FIG. 6A, the release slide 120 and the battery latch 136 are biased toward the second lateral housing side 130 so that the battery latch 136 is able to glide through the guide 135 in the direction 604 toward the second housing end 116 and continuing to glide the battery 110, until the housing rail 140 and the battery rail slot 148 are fully disengaged from one another, effectively releasing the battery 110 from the battery housing assembly 108.

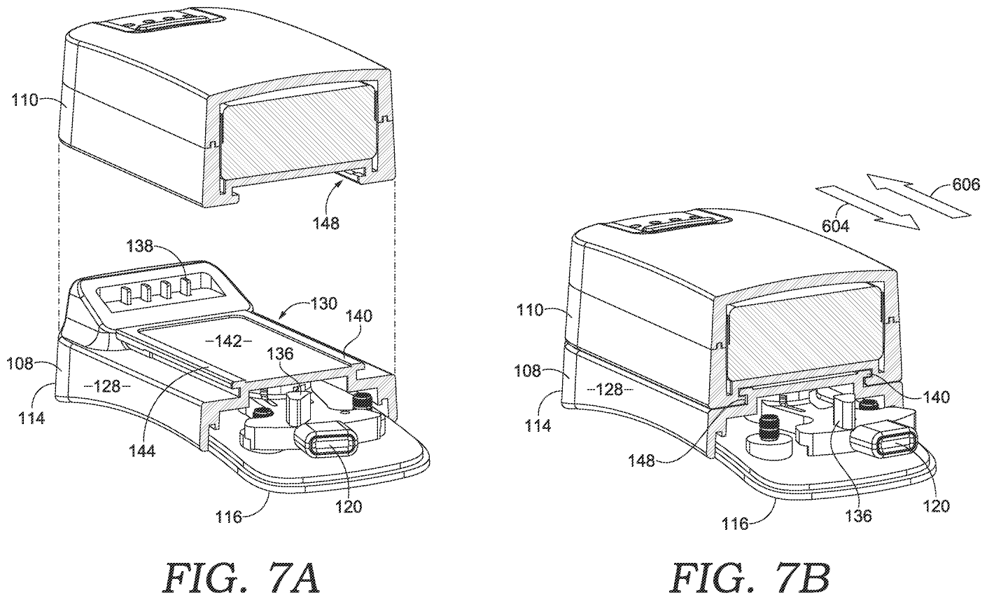

The partial cross-sectional view of the battery system shown in FIG. 7B illustrates how the housing rail 140 engages with the battery rail slot 148 as the battery 110 is glided in the direction 604 toward the second housing end 116 when the slide 120 is in the unlocked position. Similarly, the partial cross-sectional view of the battery system 110 shown in FIG. 7B also illustrates how the housing rail 140 engages with the battery rail slot 148 as the battery 110 is glided in the direction 606 toward the first housing end 114, and when the slide 120 is in its locked position if the battery housing assembly 108 (shown in FIGS. 7A and 6B.

Further, when the battery 110 and the battery housing assembly 108 are secured to each other when the release slide 120 is in its locked position, as shown in FIG. 6B, the battery latch 136 is blocked by a ridge 133, so that the battery 110 is no longer able to be glided in the direction 604 toward the second housing end 116, effectively locking the battery 110 to the battery housing assembly 108. When in the locked position, the battery contact 138 of the battery housing assembly 108 engages with the battery contact 139 of the battery 110, electrically connecting the battery 110 to the battery housing assembly 108. An advantage of the separable battery system can be that the battery 110 can be changeable or replaceable, without having to replace the battery housing 108 as well, and to allow charging at other charging stations.

It is also contemplated that in a different example, the battery 110 and the battery housing assembly 108 are not separable, or in other words, may be a unitary piece. Having a unitary piece for the battery 110 and the battery housing assembly 108 may be advantageous to minimize moveable parts in applications where, for example, the user is constantly moving about, or exposed to repeated jerking/yanking type motions.

The device 102 can be generally positioned at a front of a user's head while the battery housing assembly 108 and the battery 110 can be generally positioned a fixed length away from the device 102 based on the a length of the fixed length strap 104. The distance between the device 102 and the battery housing assembly 108 created by the fixed length strap 104 can locate the battery housing assembly 108 and the battery toward the back of the wearer's head to provide customizable counterbalancing of the weight of the device 102 and the battery system including the battery housing assembly 108 and the battery 110. To position the battery housing assembly 108 near the back of the wearer's head, or offset from the back of the wearer's head, in most users, the fixed length strap may be eight inches long or less. In aspects, the fixed length strap 104 may be six inches long or less. In aspects, the fixed length strap 104 may be four inches long or less. Other measurements may be used to position the battery housing 108 a fixed length from the device 102 to help balance the weight, while also positioning the battery housing assembly 108 at the rear or offset from the rear of the wearer's head when the variable length strap 106 is adjusted. Spacing the battery housing assembly 108 and battery 110 from the device 102 can allow for the inclusion of a larger, longer lasting, or more efficient battery 110 without adding bulk to the device 102 itself, when compared to a traditional headgear, and can also provide improved and secure placement of the headgear 100 when a length of the variable length strap 106 is adjusted.

For example, when the variable length strap 106 is fully retracted, a variable length of the variable length strap 106 can be shorter than the fixed length of the fixed length strap 104, and when the variable length strap 106 is fully extended, the variable length of the variable length strap 106 can be longer than the fixed length of the fixed length strap 104. The length of the variable length strap 106 can be changed by manipulating, for example, one or more strap adjusters 112a and/or 112b, which are configured to glide along the length of the variable length strap 106. For example, when the variable length strap 106 is fully retracted, the whole length of the variable length strap 106 may be double layered as shown in zone 101, or the variable length strap 106 may be single layered as shown in zone 103 when fully extended (see FIG. 1 and FIG. 2). As such, length distribution between zone 101 and zone 103 may change as the length of the variable length strap 106 is adjusted. In other words, when the length of zone 101 is greater than the length of zone 103, the strap will be shorter than when the length of zone 103 is greater than the length of zone 101. While depicted as a two-bar slide adjuster in the figures, the one or more variable length strap adjusters 112a and 112b may take the form of any suitable length adjuster for shortening or increasing the length of the variable length strap 106.

The variable length strap 106 can be formed of an adjustable material or system. Synthetic materials such as polyester, nylon, polypropylene, and the like, including woven, braided, knit, molded, nonwoven constructions or the like, may be used. Additionally, natural materials such as leather, cotton, hemp also including woven, braided, knit, molded, nonwoven constructions, or the like, may be used.

The fixed length strap 104 can be formed of a resilient and rigid or semi-rigid material holding its shape, while still having some flexibility so that the positioning of the device 102 relative to the battery housing assembly 108 can generally be maintained while still allowing the headgear 100 to be adaptable for a particular user's needs. For example, some materials that may be used for the fixed length strap 104 comprise synthetic and natural rubbers and/or plastics (e.g., thermoplastic polyurethane, polyester, silicone, polyurethane), or other like materials. For instance, suitable materials may be synthetic materials having a Shore A value from 20A to 60A on the Shore A hardness scale.

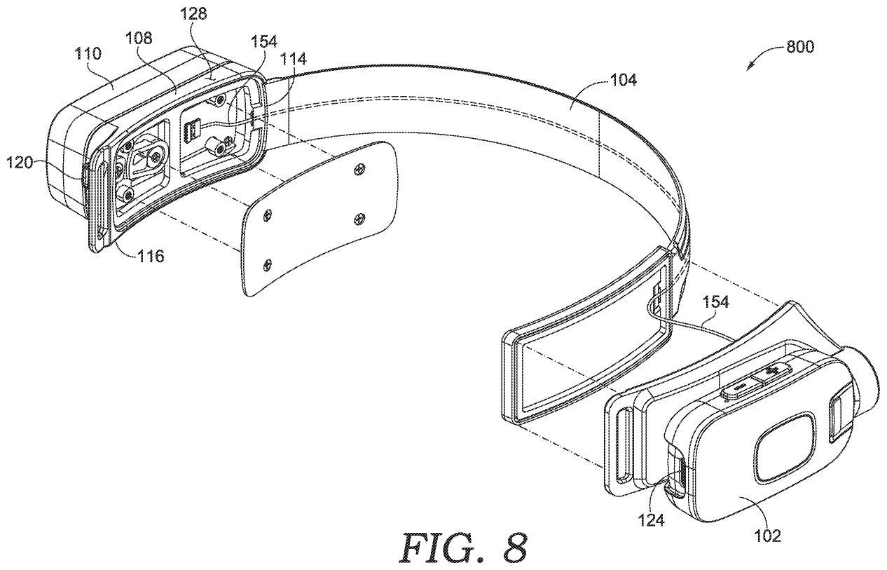

The battery housing assembly 108 and battery 110 may be electrically connected to the device 102 and charging port 124 via the fixed length strap 104, where the power cable 154 is housed, as shown in FIG. 8. The power cable 154 providing the electrical connection between the battery housing assembly 108 and the battery 110 with the charging port 124 located in the device 102, can be overmolded or press molded by the resilient material forming the fixed length strap 104. The electrical connection to the charging port 124 is shown in greater detail in FIG. 9. For efficient cable management, the power cable 154 has a fixed length that when fully extended, connects the battery housing assembly 108 to the charging port 124. As such, the charging port 124 can serve both to charge the battery and to transfer data to and from the device 102, further giving the advantage of reducing the number of open ports.

To protect the charging port 124 the charging port 124 may be provided with a cover 126, which may be linked to the device 102 through connectors 132. The cover 126 may be provided with a tab 134 to aid the user in opening and closing the cover 126 by providing an anchoring area for, for example, a nail of the user or other tool.

Having identified various components utilized herein, it should be understood that any number of components and arrangements can be employed to achieve the desired functionality within the scope of the present disclosure. For example, the components in the examples depicted in the figures are shown with lines for the sake of conceptual clarity. Other arrangements of these and other components can also be implemented. For example, although some components are depicted as single components, elements described herein can be implemented as discrete or distributed components or in conjunction with other components, and in any suitable combination and location. Some elements can be omitted altogether.

The subject matter of the present technology is described with specificity herein to meet statutory requirements. However, the description itself is not intended to limit the scope of this disclosure. Rather, it is contemplated that the subject matter might also be embodied in other ways, to include different steps or combination of steps similar to the ones described in this document, in conjunction with other present or future technologies.

Examples described above may be combined with one or more of the specifically described alternatives. In particular, an example that is claimed may contain a reference, in the alternative, to more than one other example. The example that is claimed may specify a further limitation of the subject matter claimed.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Terms, such as “having,” “including,” or the like, and derivatives thereof, are intended to have the same broad meaning as “comprising,” unless otherwise expressly indicated.

Unless explicitly indicated otherwise, ranges are intended to provide examples that are suitable for some aspects and implementations. They are not intended to exclude other examples of the technology having values falling outside of the given ranges.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible examples of the described technology may be made without departing from the scope, it is to be understood that all matter described herein or illustrated in the accompanying drawings is to be interpreted as illustrative and not in a limiting sense.

What is claimed is:

1. A battery system for a headgear comprising:
a battery housing assembly, the battery housing assembly comprising a first housing end opposite a second housing end;
a fixed length strap extending from the battery housing assembly at the first housing end;
a variable length strap extending from the battery housing assembly at the second housing end; and
a fixed length power cable extending from the battery housing assembly and through the fixed length strap, wherein the fixed length power cable electrically couples a battery contact of the battery housing assembly to a charging port.

2. The battery system of claim 1, further comprising a housing rail extending between the first housing end and the second housing end.

3. The battery system of claim 2, wherein the housing rail comprises a battery rail receiving site at a location nearer to the second housing end than the first housing end.

4. The battery system of claim 1, further comprising a release slide, the release slide protruding through a release slide opening at the second housing end, wherein the release slide is biased toward a first longitudinal housing side, wherein moving the release slide directionally between the first longitudinal housing side and a second longitudinal housing side respectively positions a battery latch between a locked position and an unlocked position.

5. The battery system of claim 4, further comprising a top surface, the top surface comprising a top surface opening, wherein the battery latch extends through the top surface opening at a location nearer to the second housing end than the first housing end.

6. The battery system of claim 4, wherein the battery contact is positioned within a first lateral housing side of the battery housing assembly that comprises the first housing end and opposite a second lateral housing side of the battery housing assembly that comprises the second housing end through which the release slide protrudes.

7. The battery system of claim 1, wherein the fixed length power cable is molded by a polymer-based material, whereby the molded polymer-based material at least partially encases the power cable along the fixed length strap.

8. A headgear comprising:
a battery housing assembly;
a fixed length strap extending from the battery housing assembly in a first direction;
a variable length strap extending from the battery housing assembly in a second direction opposite the first direction; and
a fixed length power cable extending from the battery housing assembly and through the fixed length strap, wherein the fixed length power cable electrically couples a battery contact of the battery housing assembly to a charging port.

9. The headgear of claim 8, further comprising a housing rail extending between a first housing end and a second housing end of the battery housing.

10. The headgear of claim 9, wherein the housing rail comprises a battery rail receiving site at a location nearer to the second housing end than the first housing end.

11. The headgear of claim 9, further comprising a release slide, the release slide protruding through a release slide opening at the second housing end, wherein the release slide is biased toward a first longitudinal housing side, wherein moving the release slide directionally between the first longitudinal housing side and a second longitudinal housing side respectively positions a battery latch between a locked position and an unlocked position.

12. The headgear of claim 11, further comprising a top surface, the top surface comprising a top surface opening, wherein the battery latch extends through the top surface opening at a location nearer to the second housing end than the first housing end.

13. The headgear of claim 11, wherein the battery contact is positioned within a first lateral housing side of the battery housing assembly that comprises the first housing end and opposite a second lateral housing side of the battery housing assembly that comprises the second housing end through which the release slide protrudes.

14. The headgear of claim 11, wherein the fixed length power cable is molded by a polymer-based material, whereby the molded polymer-based material at least partially encases the power cable along the fixed length strap.

15. A headgear comprising:
a battery housing assembly having a housing rail configured to accept a removable battery, the battery housing comprising a first housing end opposite a second housing end;
a fixed length strap extending from the battery housing assembly at the first housing end;
a variable length strap extending from the battery housing assembly at the second housing end; and
a fixed length power cable extending from the battery housing assembly and through the fixed length strap, wherein the fixed length power cable electrically couples a battery contact of the battery housing assembly to a charging port of the headgear.

16. The headgear of claim 15, wherein the fixed length power cable is molded by a polymer-based material, whereby the molded polymer-based material at least partially encases the power cable along the fixed length strap.

17. The headgear of claim 15, further comprising:
a housing rail extending between the first housing end and the second housing end, wherein the housing rail comprises a battery rail receiving site; and
the battery, the battery comprising a battery rail slot through which the battery rail receiving site of the housing rail engages with the battery rail slot.

18. The headgear of claim 15, further comprising a release slide, the release slide protruding through a release slide opening at the second housing end, wherein the release slide is biased toward a first longitudinal housing side, wherein moving the release slide directionally between a first longitudinal housing side and a second longitudinal housing side respectively positions a battery latch between a locked position and an unlocked position.

19. The headgear of claim 18, further comprising a top surface, the top surface comprising a top opening, wherein the battery latch extends through the top surface opening at a location nearer to the second housing end than the first housing end.

20. The headgear of claim 18, wherein the battery contact is positioned within a first lateral housing side of the battery housing assembly that comprises the first housing end and opposite a second lateral housing side of the battery housing assembly that comprises the second housing end through which the release slide protrudes.
